(19) United States
(12) Patent Application Publication
(10) Pub. No.: US 2025/0068750 A1
(43) Pub. Date: Feb. 27, 2025

(54) ANALYSIS APPARATUS, ANALYSIS METHOD, AND NON-TRANSITORY COMPUTER READABLE MEDIUM

(71) Applicant: NEC Corporation, Minato-ku, Tokyo (JP)

(72) Inventors: Shohei MITANI, Tokyo (JP); Hirofumi Ueda, Tokyo (JP)

(73) Assignee: NEC Corporation, Minato-ku, Tokyo (JP)

(21) Appl. No.: 18/723,955

(22) PCT Filed: Jan. 26, 2022
(86) PCT No.: PCT/JP2022/002794

§ 371 Date: Jun. 25, 2024

(51) Int. Cl. G06F 21/62

(52) U.S. Cl. CPC G06F 21/62

(57) ABSTRACT

An analysis apparatus according to an example embodiment of the present disclosure includes at least one memory configured to store instructions; and at least one processor configured to execute the instructions to acquire a data set in which a plurality of combinations of a first pattern of one or more elements indicating an access attribute and an access control action associated with the first pattern are defined, and a second pattern of one or more elements indicating an access attribute, and estimate at least one of an order or magnitude of the degree of influence of the second pattern influencing the action by using the data set and the second pattern.

### TECHNICAL FIELD

The present invention relates to an analysis apparatus, an analysis method, and a non-transitory computer readable medium.

### BACKGROUND ART

Access control in a network is crucial for securing network security and necessary access.

For example, cited Patent Literature 1 discloses a system that extracts an access control policy from an access check mechanism having a policy expression capability limited to more than the access control policy as a method for implementing a computer resource access control policy.

### CITATION LIST

### Patent Literature

Patent Literature 1: Published Japanese Translation of PCT International Publication for Patent Application, No. 2009-540397

### SUMMARY OF INVENTION

### Technical Problem

It is an object of the present disclosure to provide an analysis apparatus, an analysis method, and a non-transitory computer readable medium which are capable of contributing to accurately deciding an access control action.

### Solution to Problem

An analysis apparatus according to an example embodiment includes an acquisition means that acquires a data set in which a plurality of combinations of a first pattern of one or more elements indicating an access attribute and an access control action associated with the first pattern are defined, and a second pattern of one or more elements indicating an access attribute, and an estimation means that estimates at least one of an order or magnitude of the degree of influence of the second pattern influencing the action by using the data set and the second pattern.

An analysis method according to an example embodiment is executed by a computer, and includes acquiring a data set in which a plurality of combinations of a first pattern of one or more elements indicating an access attribute and an access control action associated with the first pattern are defined, and a second pattern of one or more elements indicating an access attribute, and estimating at least one of an order or magnitude of the degree of influence of the second pattern influencing the action by using the data set and the second pattern.

A non-transitory computer readable medium according to an example embodiment has a program stored therein, and the program causes a computer to execute acquiring a data set in which a plurality of combinations of a first pattern of one or more elements indicating an access attribute and an access control action associated with the first pattern are defined, and a second pattern of one or more elements indicating an access attribute, and estimating at least one of an order or magnitude of the degree of influence of the second pattern influencing the action by using the data set and the second pattern.

### Advantageous Effects of Invention

According to the present disclosure, it is possible to provide an analysis apparatus, an analysis method, and a non-transitory computer readable medium which are capable of contributing to accurately deciding an access control action.

### BRIEF DESCRIPTION OF DRAWINGS

FIG. 1 is a block diagram illustrating an example of an analysis apparatus according to a first example embodiment.

FIG. 2 is a flowchart illustrating an example of a process in an analysis apparatus according to the first example embodiment.

FIG. 3 is a block diagram illustrating an example of a policy generation system according to a second example embodiment.

FIG. 4 is a conceptual diagram illustrating a process performed by an intention extraction unit and a policy generation unit according to the second example embodiment.

FIG. 5 illustrates an example of an intention extracted by an intention extraction model according to the second example embodiment.

FIG. 6 is a block diagram illustrating an example of a hardware configuration of an apparatus according to each example embodiment.

### EXAMPLE EMBODIMENT

Example embodiments of the present disclosure will be described below with reference to the drawings. Note that, in the description and drawings to be described below, omission and simplification are made as appropriate for clarity of description. Further, in the present disclosure, unless otherwise specified, in a case in which “at least one” is defined for a plurality of items, the definition may mean any one item or may mean any two or more items (including all items).

### First Example Embodiment

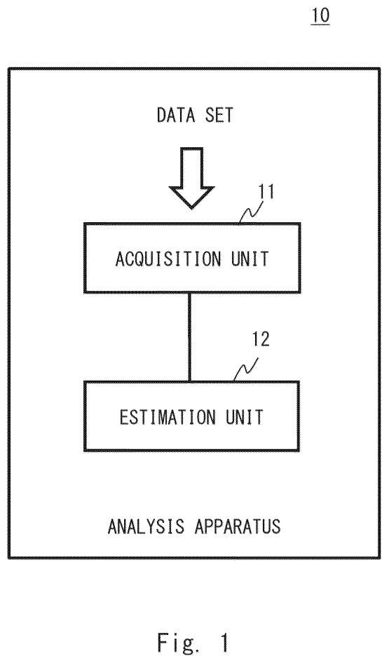

FIG. 1 is a block diagram illustrating an example of an analysis apparatus.

The analysis apparatus 10 includes an acquisition unit 11 and an estimation unit 12. Each unit (each means) of the analysis apparatus 10 is controlled by a control unit (controller) (not illustrated). Each unit will be described below.

The acquisition unit 11 acquires a data set in which a plurality of combinations of a first pattern of one or more elements indicating an access attribute and an access control action associated with the first pattern are defined, and a second pattern of one or more elements indicating an access attribute. One or more patterns may be present as the second pattern. Note that the acquisition unit 11 includes an interface that acquires information from the inside or outside of the analysis apparatus 10. The acquisition process may be automatically executed by the acquisition unit 11 or may be performed by manual input.

Here, “the element indicating the access attribute” in the first pattern and the second pattern indicates any element specifying a property of access. Specific examples of the element may include any one or more pieces of specific information (values) related to the property of access, such as (1) various types of data of an access source, (2) various types of data of an access destination, and (3) other data indicating the property of access.

Specific examples of (1) various types of data of the access source include any one or more items among information regarding an ID of the access source, information regarding a user, information regarding a device of the access source, information regarding an Internet Protocol (IP) address of the access source, information regarding a port number, a software name (for example, an application name), an access authentication means, and the like. Here, the information regarding the ID of the access source includes any one or more pieces of information among an ID of the access source (user ID), a user name, a device ID, an application ID, a user authentication result (authentication history) of the ID of the access source, and the like. The information regarding the user includes any one or more pieces of information among an affiliation (organization), a title, and a job category of the user, a user position (a position of a device which is an access source), and the like. The information regarding the device of the access source includes any one or more among operation system (OS) used by the device of the access source, and a manufacturer name. The information regarding the IP address of the access source includes any one or more pieces of information among the IP address of the access source, the risk level of the IP address of the access source, and the like.

Specific examples of (2) various types of data of the access destination include any one or more pieces of information among information regarding an ID of the access destination, information regarding data of the access destination, an IP address of the access destination, information regarding an OS used by the device of the access destination, an operation type, and the like. The information regarding the ID of the access destination includes any one or more pieces of information among a resource ID of the access destination, an owner name of the resource ID of the access destination, and the like. The information regarding the data of the access destination includes any one or more pieces of information among an organization of the access destination (an organization having a resource), a type of data (resource) of the requested access destination, a creator, a creation date and time, a security level, and the like.

Specific examples of (3) other data indicating the property of access include any one or more pieces of data among a request frequency from the ID of the access source to the resource ID of the access destination, an access time zone (or time), a session key scheme, the degree of abnormality, encryption strength of traffic, various types of data regarding authentication, and the like. The various types of data regarding the authentication include any one or more pieces of data among various types of authentication methods (including, for example, information on authentication strength), device authentication results, application authentication results, various types of authentication times, the number of failures of various types of authentication, and the like. However, the elements described above are merely examples, and the elements indicating the access attribute are not limited thereto.

The “pattern of one or more elements indicating the access attribute” mean that one or more elements are present. For example, X, Y, and Z are assumed as the access attribute, X1 and X2 are assumed as elements of different values of the same attribute X, Y1 and Y2 are assumed as elements of different values of the same attribute Y, and Z1 and Z2 are assumed as elements of different values of the same attribute Z. In this case, any one or more patterns among “X1”, “Y1”, “Z1”, “X1, Y1”, “X1, Z1”, “Y1, Z1”, “X1, Y2”, . . . “X1, Y1, Z1”, . . . “X2, Y2, Z2” are included as the “pattern of the element indicating the access attribute”. Note that at least one or more elements among the elements constituting each of the first pattern and the second pattern may be different.

The data set further includes access control actions which are associated with the respective first patterns. Different actions of two or more steps are defined as the actions. For example, two or more types of actions among approval, denial, and conditional approval (additional approval required) may be defined as the actions. However, the actions described above are merely examples, and the types of actions are not limited thereto.

In the data set, a plurality of combinations of the first pattern of one or more elements indicating the access attribute described above and the access control action respectively associated with the first patterns are defined. For example, in a case in which there are “X1, Y1”, “X1, Z1”, and “Y1, Z1” as the patterns of a plurality of elements indicating the access attribute, and there are “approval”, “denial”, and “approval” as the actions associated with the respective patterns, “X1, Y1→ approval”, “X1, Z1→->denial”, and “Y1, Z1→ approval” are defined in the data set as the combinations thereof.

The estimation unit 12 estimates at least one of the order or magnitude of the degree of influence of the second pattern influencing the access control action by using the data set and the second pattern acquired by the acquisition unit 11. The order of the degrees of influence means directivity in which an action is directed in a direction of approval or a direction of denial in accordance with the pattern of the element defined. The expression “the action is directed in the direction of approval” means, for example, at least one of the following: the action changes from “denial” to “approval”, from “additional authentication request” to “approval”, and from “denial” to “additional authentication request”. Further, the magnitude of the degree of influence means the degree of magnitude of the change in an action. For example, it can be said that the degree of influence is larger when the action changes from “denial” to” approval” than when the action changes from “additional authentication request” to “approval” or from “denial” to “additional authentication request”. Further, it can be said that the degree of influence is larger when the action changes from “approval” to “denial” than when the action changes from “approval” to “additional authentication request” or from “additional authentication request” to “denial”. Information on the estimated order or magnitude of the degree of influence may be stored in the analysis apparatus 10 or output to the outside of the analysis apparatus 10 (for example, displayed to the user), or may be used for policy generation as described in the second example embodiment.

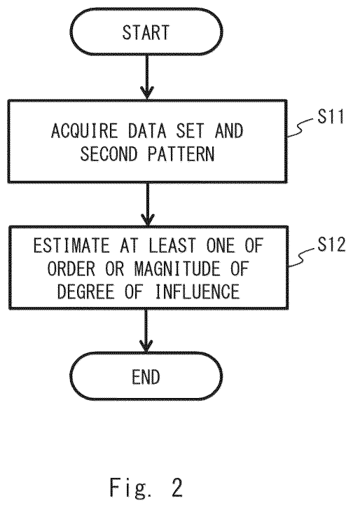

FIG. 2 is a flowchart illustrating an example of a representative process of the analysis apparatus 10, and processing of the analysis apparatus 10 will be described with this flowchart. First, the acquisition unit 11 of the analysis apparatus 10 acquires the data set in which a plurality of combinations of the first pattern of one or more elements indicating the access attribute and the access control action associated with the first pattern are defined, and the second pattern of one or more elements indicating the access attribute (step S11: acquisition step). Next, the estimation unit 12 estimates at least one of the order or magnitude of the degree of influence of the second pattern influencing the action by using the data set and the second pattern (step S12: estimation step). By using the order or magnitude of the degree of influence estimated in this manner, it is possible to accurately decide the access control action for a pattern of any element.

### SECOND EXAMPLE EMBODIMENT

Hereinafter, example embodiments of the present invention will be described with reference to the drawings. The second example embodiment discloses a specific example of the analysis apparatus 10 described in the first example embodiment.

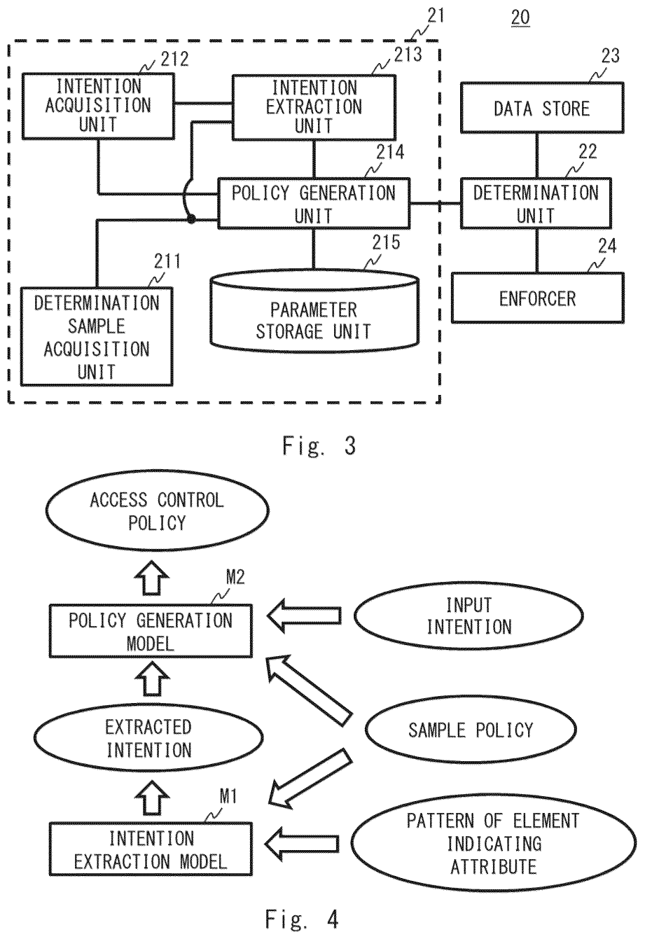

FIG. 3 is a block diagram illustrating an example of an access control system 20 that performs an access control determination over a zero trust network. The access control system 20 includes a policy generation system 21, a determination unit 22, a data store 23, and an enforcer 24. The details of each unit will be described below.

The policy generation system 21 is equivalent to a specific example of the analysis apparatus 10 according to the first example embodiment. The policy generation system 21 generates an access control policy for access control on the basis of an input intention (knowledge necessary for policy generation) and a determination sample (equivalent to the data set in the first example embodiment), and outputs the generated access control policy to the determination unit 22. The details of the policy generation system 21 will be described later.

Here, the access control policy is a policy in which a plurality of combinations of a pattern (a fifth pattern) of one or more elements indicating an access attribute and an access control action associated with the pattern of the plurality of elements are defined. As a specific example, in a case in which a combination of elements is (affiliation of the user of the access source: division A, job category: developer, authentication method: two-step authentication, organization having a resource: division A, resource type: design document), an action associated therewith is defined as “approval”.

When an access control inquiry (request) is made using the access control policy acquired from the policy generation system 21, the determination unit 22 determines an access control action on the basis of an element related to the request. The element related to the request means the same element as the element indicating the access attribute described in the first example embodiment.

Specifically, (i) information of the element indicating the access attribute included in the request and (ii) other information of a background attribute are input to the determination unit 22 as the elements related to the request. As an example of the information of (i), the ID of the access source, the IP address of the access source, the resource ID of the access destination, an operation type, a session key, and the like are assumed, but the information of the element included in the request is not limited thereto. Further, as an example of the information of (ii), the user name of the ID of the access source, an affiliation, the title or the job category of the user, the manufacturer name of the device, the user position, the user authentication result, the risk level of the IP address of the access source, the owner name of the resource ID of the access destination, the type and creation date and time of the data of the access destination, the encryption strength, the request frequency from the ID of the access source to the resource ID of the access destination, the time of access, various types of authentication methods, the device authentication result, the application authentication result, various types of authentication times, the number of failures of various types of authentication, and the like are assumed, but the information of the element included in the information of the background attribute is not limited thereto.

The determination unit 22 compares the element related to the request with a combination of a plurality of elements defined in the access control policy, and specifies a combination of elements defined in the access control policy that satisfies the condition of the element related to the request. Then, the action defined in association with each combination is decided as the action for the request, and information of the action is output.

The actions that can be taken in the second example embodiment are approval, an additional authentication request, denial, and the like, but are not limited thereto. For example, transfer of access to a server that performs a more detailed check, an approval request to an administrator, or the like can be considered as the action. This action constitutes the totally ordered set that satisfies the reflexive law, the transitive law, the asymmetric law, and the perfect law.

The determination unit 22 described above can be implemented by any means such as a proxy server for access control, an application gateway, or attribute-based encryption.

The data store 23 is a storage (storage unit) that stores the information of the background attributes used in the determination unit 22 described above. The access control system 20 stores automatically collected data in the data store 23. In a case in which there is an access control request, the determination unit 22 acquires the information of the background attribute associated with the request with reference to the data store 23.

The enforcer 24 is an access control device, and outputs the information of the element related to the request to the determination unit 22 upon receiving the access control request. Then, information of the action decided by the determination unit 22 is acquired, and access control for the request is executed on the basis of the information of the action. In a case in which access is approved, the enforcer 24 forwards the packet for access to the resource (access destination), and in a case in which access is denied, the enforcer 24 discards the packet for access. As described above, the access control system 20 performs the access control based on the generated access control policy.

Next, the details of the policy generation system 21 will be described. As illustrated in FIG. 3, the policy generation system 21 includes a determination sample acquisition unit 211, an intention acquisition unit 212, a policy generation unit 214, a parameter storage unit 215, and an intention extraction unit 213. Each unit will be described below.

The determination sample acquisition unit 211 acquires a determination sample and outputs the determination sample to the intention extraction unit 213 and the policy generation unit 214. The determination sample includes a plurality of sample policies defined by the user (or an existing automation technique). The sample policy is one in which a correspondence relationship between the pattern of one or more (for example, a plurality of) elements indicating the access attribute (first pattern) and the access control action for the pattern is defined. Here, a plurality of sample policies may be defined for each individual policy from different viewpoints. For example, the elements such as the encryption strength of traffic, the OS version of the device of the access source, the application authentication result, the authentication strength of the user, the creator of the resource, and the type of resource may be set as the viewpoint based on the security function. Further, the elements such as the title and affiliation of the user (for example, an assigned project), the creator of the resource, the type of resource, and the user position may be set as a viewpoint based on a department structure (affiliation, title, and the like) of an organization in access. As described above, the different viewpoints may have different elements or the same elements. A specific example of the sample policy is “the affiliation and title of the user, the authentication means, the position of the device, the OS, the type of data (request data) of access destination requested, the application name→approval/denial”.

Further, the sample policy may be expressed in a format in which some of the elements are hardly uniquely specified (That is, “anonymized”). For example, the affiliation of the user in the sample policy is expressed as “human resources department” and “development department” in the non-anonymized state, whereas the affiliation is expressed as “department A” and “department B” in the anonymized state. For example, the anonymization is performed to protect confidential information of the organization when the sample policy is presented to a person or system outside the organization. Alternatively, it is also assumed that the anonymization is performed because originally, in generating the sample policy, an element of underlying data is not uniquely specified (for example, the readability of the underlying data is low). Even in a case in which the sample policy has an incomplete definition as described above, the policy generation system 21 can generate a policy that interpolates the incomplete definition in the sample policy as described below.

The determination sample acquisition unit 211 may output the acquired determination sample to the intention extraction unit 213 and the policy generation unit 214 without change. Alternatively, the determination sample acquisition unit 211 may further acquire data indicating ideal access control for a pattern of a specific element and output the data to the intention extraction unit 213 and the policy generation unit 214. The number of patterns included in this data may be, for example, about a few to several tens of patterns, but is not limited thereto. Accordingly, the accuracy of the policy generated by the policy generation unit 214 can be further improved.

The intention acquisition unit 212 acquires an intention assumed to be used by a decision maker in deciding an action on the basis of one or more elements. The intention means knowledge necessary for policy generation as described above, and more specifically, includes a pattern of one or more elements indicating an access attribute (is associated with the second pattern in the first example embodiment).

The intention acquisition unit 212 can acquire, as an intention, a pattern (third pattern) of one or more elements indicating an access attribute in which the order and magnitude of the degree of influence influencing an action are defined, and a pattern (fourth pattern) of one or more elements indicating an access attribute in which at least one of the order or magnitude of the degree of influence defined in the third pattern is not defined. In this example, it is assumed that both of the order and magnitude of the degree of influence are not defined in the fourth pattern. Further, as described later, the intention is allowed to be defined in an ambiguous format. The intention acquisition unit 212 can acquire any number of combinations which is equal to or more than 1.

As an example of the pattern of one or more elements, a set of “the affiliation of the user, the type of request data, or the organization having the resource”, a set of “the OS, the software name, or the application name”, a single “authentication means”, the “degree of abnormality”, and the like can be considered. For example, in the access control, it is considered that the type of data or the organization having the resource to be allowed to be accessed is considered to differ depending on the affiliation of the user. Therefore, “the affiliation of the user, the type of request data, or the organization having the resource” may be defined as the element of intention. Similarly, in the access control, it is considered that the security level of the access can change (that is, the approval or denial of access may change) depending on the combination of the OS of the access source and the software or the application, the authentication means, and the degree of abnormality, thus “the OS, the software name, or the application name”, “the authentication means”, and “the degree of abnormality” may be defined as the elements of the intention.

Further, in the third pattern, the information of the degree of influence influencing the action is information indicating how much the action moves in the direction of “approval” or “denial”. As described above, the directivity toward “approval” or “denial” is defined as the “order of the degree of influence”, and information indicating the degree of movement to “approval” or “denial” is defined as the “magnitude of the degree of influence”. For example, the “order of the degree of influence” is obtained by arranging the “magnitudes of the degrees of influence” in descending order. The information of the degree of influence does not necessarily indicate the action to be executed itself.

Here, as the degree of influence in the intention, the intention acquisition unit 212 may acquire data such as a numerical value which is quantitatively expressed, or may acquire information of a qualitative (ambiguous) format. specific example of the latter is, for example, information indicating that “affiliation of the user: development department, request data: design data” is greater than “affiliation of the user: development department, request data: personnel data” with respect to the directionality in which the action is directed towards “approval”. The reason why this information can be defined is that it is generally natural that the user belonging to the development department requests data (for example, design data) associated with product development, and it is considered appropriate that the access control related to the data is approved. On the other hand, in a case in which the user belonging to the development department is developing the human resources system, it may be appropriate to approve access to personnel data for the purpose of development. Therefore, the degree of influence is qualitative information indicating a general tendency, unlike information of a quantitative form indicating whether to actually approve or deny. Note that the magnitude of the degree of influence may be expressed with three or more steps (for example, it can be expressed as the “degree of influence is large”, the “degree of influence is slightly large”, and the “degree of influence is small” in descending order of the degree of influence) instead of two steps.

In a case in which the qualitative information of the degree of influence is acquired, the intention acquisition unit 212 may change the information of the degree of influence as a numerical value in which the order and magnitude of the degree of influence are defined, and then output the information to the policy generation unit 214. For example, in a case in which a positive score is assigned as the directivity of “approval”, since “affiliation of the user: development department, request data: design data” is more likely to be approved for the action than “affiliation of the user: development department, request data: personnel data”, the intention acquisition unit 212 may assign the numerical value of the degree of influence “1” to the former and the numerical value of the degree of influence “0” to the latter.

The intention acquisition unit 212 outputs information of the intention regarding the third pattern and the fourth pattern to the intention extraction unit 213 and the policy generation unit 214 as described above.

When the policy generation unit 214 generates the access control policy, the intention extraction unit 213 extracts an intention that is necessary for the generation but not yet acquired by the intention acquisition unit 212, and outputs the information to the policy generation unit 214. The extracted intention is, for example, one in which the anonymized definition is uniquely identified in the sample policy (an incomplete definition is interpolated). The intention extraction unit 213 can estimate and extract an intention that does not contradict an orientation of the user indicated by the sample policy even for a pattern that is not determined by the user who has set the sample policy. This is realized such that the intention extraction unit 213 extracts, as an intention, information of the degree of influence in the fourth pattern (that is, it is information on the order and magnitude of the degree of influence influencing the action and is a numerical value in this example). The intention extraction unit 213 is equivalent to the estimation unit 12 in the first example embodiment.

Specifically, the intention extraction unit 213 acquires the sample policy from the determination sample acquisition unit 211, and acquires the information of the intention from the intention acquisition unit 212. An example of the acquired sample policy is “the affiliation and title of the user, the authentication means, the position of the device, the OS, the type of data (request data) of access destination requested, the application name→approval/denial”. Further, examples of the pattern of one or more elements in the acquired intention include a set of “the affiliation of the user, the type of request data, or the organization having the resource”, a set of “the OS, the software name, or the application name”, a single “authentication means”, the “degree of abnormality”, and the like.

The intention extraction unit 213 inputs these pieces of information to a model of intention extraction (hereinafter, referred to as an intention extraction model), and trains the intention extraction model to perform machine learning. Then, the intention extraction model is trained to generate and output, for each pattern, the degree of influence of the pattern of each element on the access control action for the fourth pattern in the information of the intention.

For example, in a case in which the fourth pattern includes “affiliation of the user: development department, request data: design data” and “affiliation of the user: development department, request data: personnel data”, the intention extraction unit 213 may determine that the former pattern is more likely to get the action of “approval” than the latter pattern on the basis of the sample policy. The reason for this has been described above. As a result, the intention extraction unit 213 assigns numerical values of the degree of influence “1” to the former and the degree of influence “0” to the latter. Accordingly, the intention extraction unit 213 can estimate the influence of various combinations of elements indicating attributes on policy decision and extract the influence as a new intention.

Furthermore, the access control system 20 may visualize the information of the intention extracted by the intention extraction unit 213 and cause the information to be presented to the user. The information of the intention to be presented includes information of the fourth pattern and the degree of influence estimated for each of the patterns. The presentation can be realized by causing the information of the intention to be displayed on a screen of the access control system 20 or by causing the information of the intention to be printed by a printing device connected to the access control system 20. Accordingly, the user can check the extracted intention and utilize the intention for manual definition of the access control policy or validation or correction of the generated access control policy. Note that the access control system 20 may present at least one of the sample policy acquired by the determination sample acquisition unit 211 or the information of the intention acquired by the intention acquisition unit 212 together with the extracted intention so as to facilitate the user's checking.

The policy generation unit 214 acquires the determination sample from the determination sample acquisition unit 211, acquires the information of the intention from the intention acquisition unit 212, and acquires the information of the intention extracted for the fourth pattern from the intention extraction unit 213. At this time, it becomes a state in which the degree of influence influencing the action is defined for the fourth pattern in the information of the intention by the extracted information of the intention. Then, the determination sample and the information of the extracted intention are input to an access control policy generation model (hereinafter, referred to as a policy generation model), and the policy generation model is trained to perform machine learning, and thus the access control policy that enables the output of the access control action according to the input intention is generated and output by the policy generation model. The access control policy is one in which a combination of a fifth pattern of one or more elements indicating an access attribute and an action is defined, and the fifth pattern may be a pattern including the first pattern defined in the sample policy and the third and fourth patterns defined by the information of intention.

The policy generation model can emulate a method in which an administrator or the like of the network subject to the access control decides the sample policy on the basis of the acquired intention, and decide in detail the pattern of the combination of elements and the combination of actions which are not clearly defined by the sample policy (which are, for example, ignored because they are out of the range or do not substantially affect the access control determination). Here, the policy generation model can automatically adjust the order and magnitude of the degree of influence associated with the combination of the elements based on the intention and set appropriate values thereto.

In detail, the policy generation model can generate the access control policy so that the information (order and magnitude) of the degree of influence of the fourth pattern estimated by the intention extraction unit 213 is stored. That is, the quantitative action in the fourth pattern defined in the access control policy can be made not to be contradictory to the qualitative information of degree of influence of the fourth pattern estimated by the intention extraction unit 213. Then, as an example, the generated access control policy may uniquely specify an anonymized location in the sample policy.

The policy generation unit 214 described above can be implemented by any means such as probabilistic logic, fuzzy logic, linear regression, support vector machines, decision trees, neural networks, monotonic regression, monotonic decision trees, and monotonic neural networks.

Further, the policy generation unit 214 may generate some sort of algorithm (for example, program) instead of the access control policy. As a pattern of a plurality of elements indicating a predetermined (for example, requested) access attribute is input, this program outputs an action associated with the pattern. The policy generation unit 214 outputs the program to the determination unit 22, and the determination unit 22 determines an action for the request using the program.

The parameter storage unit 215 stores parameters necessary for the policy generation unit 214 to generate the access control policy. The policy generation unit 214 acquires the parameters from the parameter storage unit 215 when generating the access control policy.

FIG. 4 is a conceptual diagram illustrating a process performed by the intention extraction unit 213 and the policy generation unit 214. FIG. 4 illustrates an intention extraction model M1 used by the intention extraction unit 213, a policy generation model M2 used by the policy generation unit 214, and data input or output to each model. Hereinafter, an overview of a process of generating the access control policy will be described again with reference to FIG. 4

The sample policy acquired by the determination sample acquisition unit 211 and the intention (for example, the fourth pattern of one or more elements indicating an attribute) acquired by the intention acquisition unit 212 are input to the intention extraction model M1. The intention extraction model M1 performs machine learning by using these data, and extracts and outputs the intention.

The sample policy acquired by the determination sample acquisition unit 211, the intention (input intention) acquired by the intention acquisition unit 212, and the intention extracted by the intention extraction model M1 are input to the policy generation model M2. The policy generation model M2 performs machine learning by using the data, and generates and outputs the access control policy.

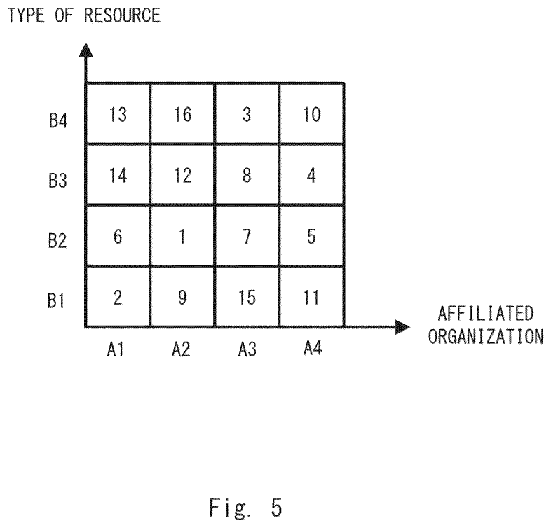

FIG. 5 illustrates an example of the intention extracted by the intention extraction model M1. The horizontal axis in FIG. 5 indicates an affiliated organization of the user, and A1, A2, A3, and A4 are set as the organization names from the left. On the other hand, the vertical axis in FIG. 5 represents the type of resource, and B1, B2, B3, and B4 are set as type names from the left.

In FIG. 5, the combinations of (affiliated organization, type of resource) are assigned rankings of 1, 2, 3, . . . 15, and 16 in descending order of the degree of influence. In other words, the intention extraction model M1 allocates (A2, B2), (A1, B1), (A3, B4), . . . (A2, B4) in descending order of the numerical value of the degree of influence as the combinations of (affiliation organization, type of resource) as a result of learning. The higher the rank, the easier it is to get “approval” as an associated action, and the lower the rank, the easier it is to get “denial” as an associated action. The combinations with high ranks may be, for example, an access with high safety from the viewpoint of security, or may be an access that is naturally accessed from the viewpoint of a department structure or the like of an organization. The reverse can be applied to the combinations with low rankings.

Note that, in this example, a set of two types of elements expressed two dimensions is assumed as the intention, but a similar intention may be extracted for a set of N types of any elements (N: natural number) expressed N dimensions.

The access control system 20 can adopt any of the following three types for learning timing of the intention extraction model M1 and the policy generation model M2 described above.

(1) The access control system 20 causes the intention extraction unit 213 and the policy generation unit 214 to simultaneously train the intention extraction model M1 and the policy generation model M2 to execute learning. At this time, the access control system 20 links the learnings of the intention extraction model M1 and the policy generation model M2 by training the intention extraction model M1 so that the accuracy of the finally generated access control policy is improved (that is, the accuracy of the policy generation model M2 is improved.).

(2) The access control system 20 causes, first, the policy generation unit 214 to train the policy generation model M2 to execute learning. Accordingly, after the policy generation model M2 is constructed, the intention extraction unit 213 trains the intention extraction model M1 to execute learning so that the output result of the policy generation model M2 approximates the access control action assumed to be actually taken by the administrator.

Note that, in (1) and (2), the intention extraction unit 213 can adjust the intention extraction model M1 to output (estimate) the degree of influence in the fourth pattern such that the degree of coincidence between the combination of the pattern of the element defined in the sample policy and the action, and the combination of the pattern of the element generated by the policy generation model M2 and the action increases.

(3) The access control system 20 causes, first, the intention extraction unit 213 to train the intention extraction model M1 to execute learning. As a result, after the intention extraction model M1 is constructed, the policy generation unit 214 is caused to train the policy generation model M2 to execute learning.

Comparing (1) to (3), in (1), complicated intention extraction and policy generation can be realized by interaction between two learning models of the intention extraction model M1 and the policy generation model M2. In addition, since learnings are performed at the same time, it is possible to expect a reduction in the total time taken for learning. On the other hand, in (2) and (3), it is possible to avoid excessive adaptation to the data set or the policy which is a learning target and to realize intention extraction and policy generation which are simpler but highly valid and robust. Note that both of the techniques of (1) and (2) can be realized by any means such as rule extraction, decision tree, clustering, linear regression, support vector machine, neural network, stochastic process regression, and constrained models thereof. Furthermore, the technique of (3) can be realized in the policy generation unit 214 by using any means such as a statistical technique such as correlation analysis (for example, an analysis of correlation between an attribute “authentication method” and an action “approval”) between an access attribute and an action or causal inference between both.

The policy generation of the policy generation system 21 described above is performed before the access control determination by the determination unit 22 starts. Accordingly, the determination unit 22 can accurately execute the access control determination by using the generated policy.

In recent years, with the progress of technology of the zero trust network, the importance of access control in the network has increased. The zero trust network can be applied, for example, in local 5th Generation (5G) used in companies, a municipalities, and the like.

The zero trust network computes a score related to security for access from all devices, and decides whether to permit the access. Accordingly, even though a threat intrudes into the network, it is possible to prevent the threat from accessing important files and to prevent spread of damage. In addition, the zero trust network performs the determination based on the score calculation described above without generally blocking access from the outside of the network, and thus can permit reliable access. Therefore, both safety and availability of the network can be achieved.

In the zero trust network, a policy engine of the network determines approval or denial of access by integrating various information based on viewpoints such as risk, need, trust, etc. In order to accurately determine approval or denial of access, it is necessary to generate a detailed policy. Further, it is desirable that the policy to be generated is dynamic in order to accurately reflect the environment change in the policy even when the environment of the network (a plurality of elements related to access control) changes. Therefore, the policy to be generated becomes complicated, and how to define or generate such a policy is a problem.

For example, in a case in which the administrator of the network subject to the access control generates a policy, the administrator may have more knowledge for a specific viewpoint (for example, a security function, a department structure, or the like) but less knowledge for other viewpoints. Therefore, the accuracy of the generated policy is degraded, and an access control action under various situations is unlikely to be accurately decided. A method in which a plurality of administrators each generates a policy and generates a policy in which the policies are integrated is also conceivable, but even in this case, the integrated policy hardly covers all of various situations, and definition omission in which an action cannot be accurately determined is likely to occur. For example, situations in which incomplete definition occurs in a part of the policy (a part is anonymized) as described above fall under such circumstances. In a case in which a person tries to check all the definitions in order to solve this problem, it is assumed that it takes a lot of time and effort.

On the other hand, in the second example embodiment, even though there is a portion that is not defined in the sample policy of the determination sample, the intention extraction unit 213 can automatically extract an intention that can interpolate the portion on the basis of the information of the intention acquired by the intention acquisition unit 212. Specifically, the intention extraction unit 213 inputs, to the intention extraction model, the sample policy (data set) in which a plurality of combinations of the pattern of the element and the access control action associated with the pattern are defined, and the information of the intention including the pattern of the element indicating the access attribute. Accordingly, it is possible to estimate the degree of influence in the pattern (fourth pattern) in the information of the intention for which the degree of influence is not defined.

Then, the policy generation unit 214 generates the access control policy by using not only the known intention but also the information of the intention newly extracted. Therefore, even in a case in which the sample policy could not be more accurate since the user who has defined the sample policy has insufficient knowledge or uniquely identifying the element fails, it is possible to increase the accuracy of the access control policy finally generated. Further, it is possible to increase the range of network systems to which the access control policy can be applied.

Further, since the administrator does not need to check all the definitions required for access control, it is possible to reduce time and effort required for access control policy generation. Further, it is not necessary to define all pieces of information necessary for generating the access control policy as the sample policy, and it is possible to cause the access control policy to be automatically generated by causing the intention acquisition unit 212 to acquire the intention (the combination of a set of one or more elements indicating the access attribute and the information of the degree of influence associated therewith).

Furthermore, the intention extraction unit 213 can estimate the order and magnitude of the degree of influence influencing the action for the pattern (fourth pattern) of one or more elements indicating the access attribute in which none of the order and magnitude of the degree of influence influencing the action is defined among the intentions acquired by the intention acquisition unit 212. Accordingly, since the intention extraction unit 213 executes the process to the extent that estimation of the degree of influence is necessary, it is possible to minimize the process of the entire access control system 20.

Furthermore, the action is defined by the totally ordered set, and the intention extraction unit 213 may estimate the order and magnitude of the degree of influence so as to become order-isomorphic as the action. Accordingly, when the degree of influence changes in the direction of approval or denial, the action defined in the access control policy changes in the direction according to the change. Accordingly, the access control system 20 may cause the determined action to reflect the administrator's intention.

Further, the policy generation unit 214 can generate the access control policy (the combination of the fifth pattern of one or more elements indicating the access attribute and the action) such that the information of the order and magnitude of the degree of influence estimated by the intention extraction unit 213 is stored. Accordingly, the access control system 20 can have the action determined by the access control policy to become an action assumed to be intended by the administrator.

Further, the intention extraction unit 213 can output (estimate) the degree of influence in the fourth pattern such that the degree of coincidence between the combination of the pattern (first pattern) of the element defined in the sample policy and the action, and the combination of the pattern of the element generated by the policy generation model M2 and the action increases. Accordingly, it is possible to have the action determined by the access control policy to become an action in which the intention of the administrator indicated in the sample policy is reflected.

Further, at the stage where the intention extraction unit 213 extracts the intention, the extracted intention may be visualized and presented to the user. As the user verifies the validity of the presented intention, the user can check the sample policy acquired by the determination sample acquisition unit 211 or the information of the intention acquired by the intention acquisition unit 212 and verify the validity thereof. In a case in which the sample policy or information of the intention is invalid, the accuracy of the access control policy can be improved by the user correcting the data and causing the determination sample acquisition unit 211 or the intention acquisition unit 212 to acquire the data. Further, it is possible to reduce the time and effort required for verifying the validity of the sample policy.

Note that the present invention is not limited to the above example embodiments, and can be appropriately changed without departing from the gist.

The fourth pattern in the second example embodiment may include the pattern of one or more elements indicating the access attribute in which one of the order or magnitude of the degree of influence influencing the action is defined. As this pattern is input to the intention extraction model M1 by the intention extraction unit 213, the intention extraction unit 213 can estimate the other of the order or magnitude of the degree of influence not defined by the pattern, and output the other of the order or magnitude of the degree of influence estimated, as the extracted intention.

Further, in the second example embodiment, the example in which the access control policy is generated using both of the order and magnitude of the degree of influence has been described, but the access control policy may be generated using only one of the order and the magnitude. In this case, as the intention acquired by the intention acquisition unit 212, the pattern (third pattern) of one or more elements indicating the access attribute in which either the order or magnitude of the degree of influence influencing the action is defined, and the pattern (fourth pattern) of one or more elements indicating the access attribute in which neither the order nor the magnitude of the degree of influence influencing the action is defined are defined. Even in this case, similarly to that described in the second example embodiment, the intention extraction unit 213 may generate and output, for each pattern, one of the order or magnitude of the degree of influence of the pattern of each element on the access control action for the fourth pattern.

Even in the above case, similarly to the second example embodiment, the policy generation unit 214 can generate the access control policy by training the policy generation model to perform machine learning by using the information of the intention extracted by the intention extraction unit 213. Therefore, the access control policy with the high accuracy can be generated.

Further, in the second example embodiment, as the method of deciding the order and magnitude of the degree of influence by the numerical values, the totally ordered set in which the numerical value of the degree of influence increases in the positive direction in a case in which the action is directed in the direction of “approval” rather than “denial” is defined, but the totally ordered set is not limited to this sample, and any method can be used.

Further, the following changes can be executed for the determination unit 22. As described above, the determination unit 22 determines the access control action when the request is made using the access control policy. Here, the determination unit 22 may not execute the process of acquiring the background attribute associated with the request with reference to the data store 23 each time the request is received. The determination unit 22 corrects a variable related to the background attribute of the access control policy acquired from the policy generation unit 214 to thereby reflect the current background attribute before the request is received. Accordingly, the determination unit 22 generates a temporary access control policy. As a result, unless the current background attribute is changed, when receiving the request, the determination unit 22 does not need to refer to the data store 23 in deciding an action, and may refer to an element in the request. As described above, when the request is received, the determination unit 22 can determine an action at a higher speed by executing the two steps of operation. In addition, since the process executed in a single request can be reduced, hardware of a control device on which the determination unit 22 is mounted can be made at low cost. Note that the temporary access control policy may be generated by the policy generation system 21 rather than the determination unit 22.

Here, the determination unit 22 may use only an element regarding an attribute of a packet header included in the request (for example, an IP address or a port number of at least one of the access source and the access destination) as data to be input to the temporary access control policy. Accordingly, a general firewall, a packet filter, a software defined network (SDN) switch, or a virtual local area network (V-LAN) as the enforcer 24 (access control device) can be used as the control device on which the determination unit 22 is mounted. Therefore, the device related to the determination unit 22 can be implemented with an inexpensive device.

In the example embodiments described above, the disclosure has been described as a hardware configuration, but the disclosure is not limited thereto. In the present disclosure, the process (steps) in the policy generation apparatus or the policy generation system explained in the above-described example embodiments can be also implemented by causing a processor in a computer to execute a computer program.

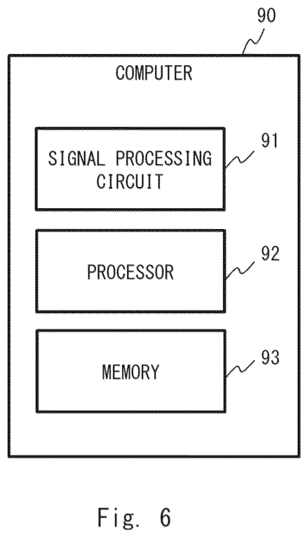

FIG. 6 is a block diagram illustrating a hardware configuration example of an information processing apparatus (signal processing apparatus) in which the processes in each example embodiment described above are executed. Referring to FIG. 6, an information processing apparatus 90 includes a signal processing circuit 91, a processor 92, and a memory 93.

The signal processing circuit 91 is a circuit for processing a signal under the control of the processor 92. The signal processing circuit 91 may include a communication circuit that receives a signal from a transmission apparatus.

The processor 92 is connected (coupled) to the memory 93, and reads and executes software (computer program) from the memory 93 to execute the processing in the apparatus described in the above-described example embodiments. As an example of the processor 92, one of a central processing unit (CPU), a micro processing unit (MPU), a field-programmable gate array (FPGA), a demand-side platform (DSP), or an application specific integrated circuit (ASIC) may be used, or a plurality of processors may be used in combination.

The memory 93 includes a volatile memory, a nonvolatile memory, or a combination thereof. The number of memories 93 is not limited to one, and a plurality of memories 93 may be provided. The volatile memory may be, for example, a random access memory (RAM) such as a dynamic random access memory (DRAM) or a static random access memory (SRAM). The nonvolatile memory may be, for example, a random only memory (ROM) such as a programmable random only memory (PROM) or an erasable programmable read only memory (EPROM), a flash memory, or a solid state drive (SSD).

The memory 93 is used to store one or more instructions. Here, one or more instructions are stored in the memory 93 as a software module group. The processor 92 can execute the processing described in the above-described example embodiments by reading and executing these software module groups from the memory 93.

Note that the memory 93 may include a memory built in the processor 92 in addition to a memory provided outside the processor 92. The memory 93 may include a storage disposed away from a processor configuring the processor 92. In this case, the processor 92 can access the memory 93 via an input/output (I/O) interface.

As described above, one or a plurality of processors included in each apparatus in the above-described example embodiments execute one or a plurality of programs including an instruction group for causing a computer to execute an algorithm described with reference to the drawings. With this processing, the signal processing method described in each example embodiment can be implemented.

The program includes a group of instructions (or software codes) for causing a computer to perform one or more functions that have been described in the example embodiments when the program is read by the computer. The program may be stored in a non-transitory computer readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disk (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes electrical, optical, acoustic, or other forms of propagated signals.

Although the present disclosure has been described above with reference to the example embodiments, the present disclosure is not limited to the above. Various modifications that could be understood by those skilled in the art can be made to the configuration and details of the present disclosure within the scope of the disclosure.

### REFERENCE SIGNS LIST

10 ANALYSIS APPARATUS
11 ACQUISITION UNIT
12 ESTIMATION UNIT
20 ACCESS CONTROL SYSTEM
21 POLICY GENERATION SYSTEM
22 DETERMINATION UNIT
23 DATA STORE
24 ENFORCER
211 DETERMINATION SAMPLE ACQUISITION UNIT
212 INTENTION ACQUISITION UNIT
213 INTENTION EXTRACTION UNIT
214 POLICY GENERATION UNIT
215 PARAMETER STORAGE UNIT

What is claimed is:

1. An analysis apparatus comprising:
at least one memory configured to store instructions; and
at least one processor configured to execute the instructions to:
acquire a data set in which a plurality of combinations of a first pattern of one or more elements indicating an access attribute and an access control action associated with the first pattern are defined, and a second pattern of one or more elements indicating an access attribute; and
estimate at least one of an order or magnitude of the degree of influence of the second pattern influencing the action by using the data set and the second pattern.

2. The analysis apparatus according to claim 1, wherein the at least one processor is further configured to:
acquire, as the second pattern, a third pattern of one or more elements indicating an access attribute in which at least one of an order or magnitude of the degree of influence influencing the action is defined, and a fourth pattern of one or more elements indicating an access attribute in which at least one of an order or magnitude of the degree of influence defined in the third pattern is not defined, and
estimate at least one of the order or magnitude of the degree of influence of the fourth pattern influencing the action.

3. The analysis apparatus according to claim 1, wherein
the action is defined by a totally ordered set, and
the at least one processor is further configured to estimate at least one of the order or magnitude of the degree of influence so as to become order-isomorphic as the action.

4. The analysis apparatus according to claim 1, further wherein the at least one processor is further configured to generate a combination of a fifth pattern of one or more elements indicating an access attribute and the action for access control such that information of the at least one of the order or magnitude of the degree of influence estimated is stored.

5. The analysis apparatus according to claim 4, wherein the at least one processor is further configured to estimate at least one of the order or magnitude of the degree of influence of the second pattern influencing the action such that the degree of coincidence between the combination of the first pattern defined in the data set and the action and the combination of the fifth pattern generated and the action increases.

6. The analysis apparatus according to claim 1, wherein the at least one of the order or magnitude of the degree of influence estimated is visualized and presented to a user.

7. An analysis method executed by a computer, the analysis method comprising:
acquiring a data set in which a plurality of combinations of a first pattern of one or more elements indicating an access attribute and an access control action associated with the first pattern are defined, and a second pattern of one or more elements indicating an access attribute; and
estimating at least one of an order or magnitude of the degree of influence of the second pattern influencing the action by using the data set and the second pattern.

8. A non-transitory computer readable medium having a program stored therein, the program causing a computer to execute:
acquiring a data set in which a plurality of combinations of a first pattern of one or more elements indicating an access attribute and an access control action associated with the first pattern are defined, and a second pattern of one or more elements indicating an access attribute; and
estimating at least one of an order or magnitude of the degree of influence of the second pattern influencing the action by using the data set and the second pattern.
